(19) United States
(12) Patent Application Publication
(10) Pub. No.: US 2013/0321147 A1
(43) Pub. Date: Dec. 5, 2013

(54) SYSTEMS AND METHODS FOR MONITORING HOW WELL MAIDS HANDLE BABIES

(71) Applicant: EDWIN Yat Wai KWONG, Hong Kong (HK)

(72) Inventor: EDWIN Yat Wai KWONG, Hong Kong (HK)

(21) Appl. No.: 13/486,979

(22) Filed: Jun. 1, 2012

(51) Int. Cl. G08B 21/02; G06K 7/01; G08B 1/08

(52) U.S. Cl. 340/539.13

(57) ABSTRACT

Systems and methods are provided for monitoring how well maids handle babies. In one embodiment, a maid monitoring system for monitoring how well maids handle babies when parents are away from home. The system includes a computer server; a watch worn by a maid, wherein the maid works in an enclosed area, such as home; a rfid reader associated with an enclosed area, wherein the rfid reader is used to monitor whereabouts of a baby; a GPS receiver included in the watch.

### FIELD OF THE INVENTION

This invention generally relates to monitoring how well maids handle babies. Specifically, this invention relates to detecting whether the maid leaves the baby unattended at home.

### BACKGROUND OF THE INVENTION

There have been alarming stories concerning maids abusing infants in Hong Kong. As an example, an Indonesian maid is accused of mixing her own urine with the formula milk she fed to a Hong Kong infant she was looking. The maid has been sentenced to jail. The scary part in the story is that the Indonesian maid did not act maliciously. Instead, the maid claimed that she added her own urine to the formula milk because of a traditional rural Indonesian belief that it makes a baby more obedient and closer to the carer. Even though in that case the baby was unharmed, this incident has raised a lot of concerns about monitoring the behavior of domestic helpers in Hong Kong, especially in families where both husband and wife are required to work outside, often leaving infants and the maid at home. In view of the foregoing, there should be adequate monitoring baby tools to help parents scrutinize maids' activities at home. Specifically, the monitoring tools should include tools that ascertain whether maids have been serving proper care when babies are hungry, tired, or crying, for example. Further, the monitoring tools should ensure that maids should not leave babies at home because leaving babies at home can be a crime, and not only maids are liable but also the employers hiring the maids can also be held liable, if proper measures are not performed in advance.

### SUMMARY OF THE INVENTION

According to embodiments of the present invention, a maid monitoring system is provided for monitoring how well maids handle babies when parents are away from home. The system comprises: a computer server; a watch worn by a maid, wherein the maid works in an enclosed area, such as home; a rfid reader associated with an enclosed area, wherein the rfid reader is used to monitor whereabouts of a baby; a GPS receiver included in the watch, wherein he GPS receiver is used to detect whether the maid is outside the enclosed area; a rfid tag included in the watch; a device worn by the baby, wherein the baby is taken care by the maid; a rfid reader included in the device worn by the baby, wherein the rfid reader: measures distance between the baby and the maid when crying occurs; detects whether the maid would immediately approach the baby; and if detected that the maid would approach the baby after crying occurs, measures how much time it would take the maid to approach the baby; a crying detector included in the device worn by the baby, wherein: the crying detector detects whether the baby is crying; and if the baby is detected crying, sending notification to the server wirelessly; a rfid tag included in the device worn by the baby, wherein the rfid tag is identified by the rfid reader associated with the enclosed area; a processor; and a memory storing instructions that can be executed by the process through a method.

In alternative embodiments, the method comprises detecting whether the maid cares for the baby when crying occurs: detecting, by the crying detector, that the baby is crying; when the baby is detected crying, using the rfid reader included in the device worn by the baby to detect where the maid is and how far she is from the baby; detecting whether the maid ignores the baby's crying, by detecting that the distance between the maid and the baby is shortening; recording information including distances between the maid and the baby, after the crying occurs; and sending the information to the server for record purposes; and detecting whether the maid leaves the baby unattended at home: at a certain period: using the GPS receiver to record location of the maid; if the GPS device indicates that the location of the GPS receiver included in the watch is outdoor, concluding that the maid is currently situated outdoor; when the maid is currently situated outdoor, using the rfid reader associated with the enclosed area to detect the rfid tag included in the device worn by the baby; and if the rfid reader associated with the enclosed area is able to detect the rfid tag included in the device worn by the baby, concluding that maid leaves the baby unattended at home. After the crying occurs; and sending the information to the server for record purposes; and detecting whether the maid leaves the baby unattended at home: at a certain period: using the GPS receiver to record location of the maid; if the GPS device indicates that the location of the GPS receiver included in the watch is outdoor, concluding that the maid is currently situated outdoor; when the maid is currently situated outdoor, using the rfid reader associated with the enclosed area to detect the rfid tag included in the device worn by the baby.

If the rfid reader is associated with the enclosed area, the embodied system is able to detect the rfid tag included in the device worn by the baby, concluding that maid leaves the baby unattended at home; and if the rfid reader associated with the enclosed area fails to detect the rfid tag included in the device worn by the baby, concluding that maid is with the baby at an outdoor environment.

When the maid is currently situated outdoor, the rfid reader associated with the enclosed area would be used to detect the rfid tag included in the device worn by the baby. If the rfid reader associated with the enclosed area is able to detect the rfid tag included in the device worn by the baby, it may be concluded that maid leaves the baby unattended at home; and if the rfid reader associated with the enclosed area fails to detect the rfid tag included in the device worn by the baby, it may further be concluded that maid is with the baby at an outdoor environment.

### BRIEF DESCRIPTION OF THE DRAWINGS

FIG. 1 illustrates a baby monitoring system, according to an embodiment of the present invention.

### DETAILED DESCRIPTION

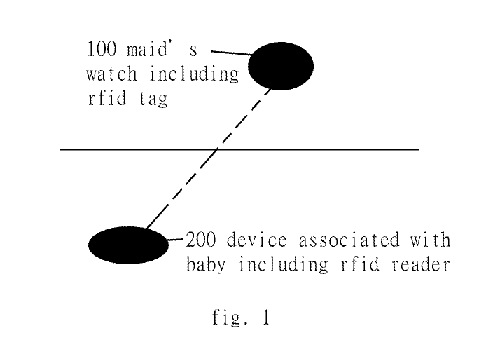

Referring to FIG. 1, a maid monitoring system is provided for monitoring how well maids handle babies when parents are away from home. The system comprises mainly a computer server; and a watch worn by a maid, wherein the maid works in an enclosed area, such as home. A rfid reader associated with an enclosed area is also included, wherein the rfid reader is used to monitor whereabouts of a baby. A GPS receiver is also included in the watch, wherein the GPS receiver is used to detect whether the maid is outside the enclosed area. The system further includes a rfid tag included in the watch; a device worn by the baby, wherein the baby is taken care by the maid; a rfid reader included in the device worn by the baby, wherein the rfid reader: measures distance between the baby and the maid when crying occurs; detects whether the maid would immediately approach the baby; and if detected that the maid would approach the baby after crying occurs, measures how much time it would take the maid to approach the baby; a crying detector included in the device worn by the baby, wherein: the crying detector detects whether the baby is crying.

If the baby is detected crying, notification is sent to the server wirelessly. The rfid tag included in the device is worn by the baby, wherein the rfid tag is identified by the rfid reader associated with the enclosed area; a processor; and a memory storing instructions that can be executed by the process through a method, the method comprising: detecting whether the maid cares for the baby when crying occurs: detecting, by the crying detector, that the baby is crying; when the baby is detected crying, using the rfid reader included in the device worn by the baby to detect where the maid is and how far she is from the baby; detecting whether the maid ignores the baby's crying, by detecting that the distance between the maid and the baby is shortening; recording information including distances between the maid and the baby, after the crying occurs; and sending the information to the server for record purposes; and detecting whether the maid leaves the baby unattended at home: at a certain period: using the GPS receiver to record location of the maid.

If the GPS device indicates that the location of the GPS receiver included in the watch is outdoor, concluding that the maid is currently situated outdoor; when the maid is currently situated outdoor, using the rfid reader associated with the enclosed area to detect the rfid tag included in the device worn by the baby; and if the rfid reader associated with the enclosed area is able to detect the rfid tag included in the device worn by the baby, concluding that maid leaves the baby unattended at home.

According to a next implementation, methods for monitoring how well maids handle babies when parents are away from home can be provided, by using a computer server; a watch worn by a maid, wherein the maid works in an enclosed area, such as home; a rfid reader associated with an enclosed area, wherein the rfid reader is used to monitor whereabouts of a baby; a GPS receiver included in the watch, wherein he GPS receiver is used to detect whether the maid is outside the enclosed area; a rfid tag included in the watch; a device worn by the baby, wherein the baby is taken care by the maid; a rfid reader included in the device worn by the baby, wherein the rfid reader: measures distance between the baby and the maid when crying occurs; detects whether the maid would immediately approach the baby; and if detected that the maid would approach the baby after crying occurs, measures how much time it would take the maid to approach the baby; a crying detector included in the device worn by the baby, wherein: the crying detector detects whether the baby is crying; and if the baby is detected crying, sending notification to the server wirelessly; a rfid tag included in the device worn by the baby, wherein the rfid tag is identified by the rfid reader associated with the enclosed area; a processor; and a memory storing instructions that can be executed by the process through a method, the method comprising: detecting whether the maid cares for the baby when crying occurs: detecting, by the crying detector, that the baby is crying; when the baby is detected crying, using the rfid reader included in the device worn by the baby to detect where the maid is and how far she is from the baby; detecting whether the maid ignores the baby's crying, by detecting that the distance between the maid and the baby is shortening; recording information including distances between the maid and the baby, after the crying occurs; and sending the information to the server for record purposes; and detecting whether the maid leaves the baby unattended at home: at a certain period: using the GPS receiver to record location of the maid; if the GPS device indicates that the location of the GPS receiver included in the watch is outdoor, concluding that the maid is currently situated outdoor.

When the maid is currently situated outdoor, the rfid reader associated with the enclosed area would be used to detect the rfid tag included in the device worn by the baby; if the rfid reader associated with the enclosed area is able to detect the rfid tag included in the device worn by the baby, concluding that maid leaves the baby unattended at home; and if the rfid reader associated with the enclosed area fails to detect the rfid tag included in the device worn by the baby, concluding that maid is with the baby at an outdoor environment.

In yet another example of the present invention, the maid monitoring system may comprise: a computer server; a watch worn by a maid, wherein the maid works in an enclosed area, such as home; a rfid reader associated with an enclosed area, wherein the rfid reader is used to monitor whereabouts of a baby; a GPS receiver included in the watch, wherein he GPS receiver is used to detect whether the maid is outside the enclosed area; a rfid tag included in the watch; a device worn by the baby, wherein the baby is taken care by the maid; a rfid reader included in the device worn by the baby, wherein the rfid reader: measures distance between the baby and the maid when crying occurs; detects whether the maid would immediately approach the baby; and if detected that the maid would approach the baby after crying occurs, measures how much time it would take the maid to approach the baby; a crying detector included in the device worn by the baby, wherein: the crying detector detects whether the baby is crying; and if the baby is detected crying, sending notification to the server wirelessly; a rfid tag included in the device worn by the baby, wherein the rfid tag is identified by the rfid reader associated with the enclosed area; a processor; and a memory storing instructions that can be executed by the process through a method, the method comprising: detecting whether the maid cares for the baby when crying occurs: detecting, by the crying detector, that the baby is crying; when the baby is detected crying, using the rfid reader included in the device worn by the baby to detect where the maid is and how far she is from the baby; detecting whether the maid ignores the baby's crying, by detecting that the distance between the maid and the baby is shortening; recording information including distances between the maid and the baby, after the crying occurs; and sending the information to the server for record purposes.

If, in a short amount of time, the distance between the baby and the maid is very close to zero, it may be concluded that the maid has cared for the baby properly; and detecting whether the maid leaves the baby unattended at home: at a certain period: using the GPS receiver to record location of the maid; if the GPS device indicates that the location of the GPS receiver included in the watch is outdoor, concluding that the maid is currently situated outdoor; when the maid is currently situated outdoor, using the rfid reader associated with the enclosed area to detect the rfid tag included in the device worn by the baby; if the rfid reader associated with the enclosed area is able to detect the rfid tag included in the device worn by the baby, concluding that maid leaves the baby unattended at home; and if the rfid reader associated with the enclosed area fails to detect the rfid tag included in the device worn by the baby, concluding that maid is with the baby at an outdoor environment.

What is claimed is:

1. A maid monitoring system for monitoring how well maids handle babies when parents are away from home, comprising:
a computer server;
a watch worn by a maid, wherein the maid works in an enclosed area, such as home;
a rfid reader associated with an enclosed area, wherein the rfid reader is used to monitor whereabouts of a baby;
a GPS receiver included in the watch, wherein he GPS receiver is used to detect whether the maid is outside the enclosed area;
a rfid tag included in the watch;
a device worn by the baby, wherein the baby is taken care by the maid;
a rfid reader included in the device worn by the baby, wherein the rfid reader:
measures distance between the baby and the maid when crying occurs;
detects whether the maid would immediately approach the baby; and
if detected that the maid would approach the baby after crying occurs, measures how much time it would take the maid to approach the baby;
a crying detector included in the device worn by the baby, wherein:
the crying detector detects whether the baby is crying; and
if the baby is detected crying, sending notification to the server wirelessly;
a rfid tag included in the device worn by the baby, wherein the rfid tag is identified by the rfid reader associated with the enclosed area;
a processor; and
a memory storing instructions that can be executed by the process through a method.

2. The system of claim 1, wherein the method comprises:
detecting whether the maid cares for the baby when crying occurs:
detecting, by the crying detector, that the baby is crying;
when the baby is detected crying, using the rfid reader included in the device worn by the baby to detect where the maid is and how far she is from the baby;
detecting whether the maid ignores the baby's crying, by detecting that the distance between the maid and the baby is shortening;
recording information including distances between the maid and the baby, after the crying occurs; and
sending the information to the server for record purposes; and
detecting whether the maid leaves the baby unattended at home:
at a certain period:
using the GPS receiver to record location of the maid;
if the GPS device indicates that the location of the GPS receiver included in the watch is outdoor, concluding that the maid is currently situated outdoor;
when the maid is currently situated outdoor, using the rfid reader associated with the enclosed area to detect the rfid tag included in the device worn by the baby; and
if the rfid reader associated with the enclosed area is able to detect the rfid tag included in the device worn by the baby, concluding that maid leaves the baby unattended at home.

3. The system of claim 1, wherein the method comprises:
detecting whether the maid cares for the baby when crying occurs:
detecting, by the crying detector, that the baby is crying;
when the baby is detected crying, using the rfid reader included in the device worn by the baby to detect where the maid is and how far she is from the baby;
detecting whether the maid ignores the baby's crying, by detecting that the distance between the maid and the baby is shortening;
recording information including distances between the maid and the baby, after the crying occurs; and
sending the information to the server for record purposes; and
detecting whether the maid leaves the baby unattended at home:
at a certain period:
using the GPS receiver to record location of the maid;
if the GPS device indicates that the location of the GPS receiver included in the watch is outdoor, concluding that the maid is currently situated outdoor;
when the maid is currently situated outdoor, using the rfid reader associated with the enclosed area to detect the rfid tag included in the device worn by the baby;
if the rfid reader associated with the enclosed area is able to detect the rfid tag included in the device worn by the baby, concluding that maid leaves the baby unattended at home; and
if the rfid reader associated with the enclosed area fails to detect the rfid tag included in the device worn by the baby, concluding that maid is with the baby at an outdoor environment.

4. The system of claim 1, wherein the method comprises:
detecting whether the maid cares for the baby when crying occurs:
detecting, by the crying detector, that the baby is crying;
when the baby is detected crying, using the rfid reader included in the device worn by the baby to detect where the maid is and how far she is from the baby;
detecting whether the maid ignores the baby's crying, by detecting that the distance between the maid and the baby is shortening;
recording information including distances between the maid and the baby, after the crying occurs; and
sending the information to the server for record purposes;
if, in a short amount of time, the distance between the baby and the maid is very close to zero, concluding that the maid has cared for the baby properly; and
detecting whether the maid leaves the baby unattended at home:
at a certain period:
using the GPS receiver to record location of the maid;
if the GPS device indicates that the location of the GPS receiver included in the watch is outdoor, concluding that the maid is currently situated outdoor;
when the maid is currently situated outdoor, using the rfid reader associated with the enclosed area to detect the rfid tag included in the device worn by the baby;
if the rfid reader associated with the enclosed area is able to detect the rfid tag included in the device worn by the baby, concluding that maid leaves the baby unattended at home; and
if the rfid reader associated with the enclosed area fails to detect the rfid tag included in the device worn by the baby, concluding that maid is with the baby at an outdoor environment.
